(19) United States
(12) Patent Application Publication
(10) Pub. No.: US 2011/0220831 A1
(43) Pub. Date: Sep. 15, 2011

(54) Film for flush valve and positioning set thereof

(76) Inventor: Mingchuan Wei, Taichung (TW)

(21) Appl. No.: 12/721,745

(22) Filed: Mar. 11, 2010

(51) Int. Cl. F16K 27/00

(52) U.S. Cl. 251/367; 251/368

(57) ABSTRACT

A film for a flush valve being integrally made of ethylene propylene diene monomer, and a hardness of the film being between shore A 70±5 degrees; a second top surface of a pressed portion the film includes a plurality of projected members arranged evenly thereon, a sum of areas of the projected members is between 12%-33% of an area of the second top surface of the pressed portion; the film being limited between a flowing loop of a positioning seat and a seat to expand and retract properly; the flowing loop including a circular recess formed on an upper side of the second fixing border to decrease a friction area as the film retracts to stabilize the retracted film; such that the film is deformed by the water pressure to expand and retract suitably so as to achieve stable water flush and water stop.

### BACKGROUND OF THE INVENTION

1. Field of the Invention

The present invention relates to a film for a flush valve and a positioning set thereof.

2. Description of the Prior Art

Conventional flush valve can strop water flush by ways of a film and is deformed under a water pressure so as to be used in draining urine or feces.

Conventional film of the flush valve is integrally made of rubber material to lower production cost but it is deformed seriously that can not stop water. Besides, if a limiting structure of the film is not designed well, for example, it is too tight to expand and retract smoothly, or when a gap is generated excessively, the film expands and deforms seriously that can not return its original shape to stop water flush.

Also, if a flowing loop of the positioning set is not deigned properly, a larger friction area of a top end of the film occurs to influence a smooth retract of the film.

Another conventional film of the flush valve is made of rubber material in which a cooper piece is wrapped to enhance a flexible deformation, however its production cost is high.

Moreover, the flowing loop of the conventional film is used to guide water flowing through the gap during water flushing process, however because a water guiding structure is not provided to the flowing loop, the flowing amount is limited under a lower water pressure.

The present invention has arisen to mitigate and/or obviate the afore-described disadvantages.

### SUMMARY OF THE INVENTION

The primary object of the present invention is to provide a film for a flush valve and a positioning set thereof. that is capable of overcoming the shortcomings of the conventional film for a flush valve and the positioning set thereof.

A film for a flush valve is integrally made of ethylene propylene diene monomer (EPDM), and a hardness of the film is between shore A 70±5 degrees; the film comprises:

a circular hole disposed at a central portion thereof, an annular engaging portion mounted around an outer periphery thereof, a circular sealing portion fixed around an outer periphery of the hole, and the sealing portion including a first top surface and a first bottom surface formed in a circular plane shape and parallel to each other, the film also comprising an annular pressed portion located between the sealing portion and the engaging portion and having a bore to flow water which extends upward obliquely so that the engaging portion is higher than the sealing portion, and a thickness of the pressed portion is less than those of the sealing portion and the engaging portion, a second top surface and a second bottom surface of the pressed portion are pressed by a water pressure to deform the pressed portion flexibly;

wherein the second top surface of the pressed portion includes a plurality of projected members arranged evenly thereon, a sum of areas of the projected members is between 12%-33% of an area of the second top surface of the pressed portion.

A positioning set adapted for the film for flush valve comprises:

a valve cylinder including a cylindrical wall, the cylindrical wall including a first fixing border extending from a top end thereof and inner threads disposed on an inner side thereof;

a flowing loop including an annular wall in which an orifice is fixed so that the lowing loop is fitted to the top end of the cylinder wall of the valve cylinder, and the flowing loop including a second fixing border below the orifice to engage with the first fixing border of the valve cylinder, wherein the annular wall includes an annular limiting portion mounted on a top end thereof and includes a number of ribs extending axially around a bottom end thereof and spaced apart from each other, and a top end of the rib connects with a bottom end of the limiting portion, a bottom end of the rib extends toward the bottom end of the annular wall;

a seat including a radial wall, an annular upper fence extending axially from a top end thereof, and a positioning slot defined between the radial wall and the upper fence; the radial wall including an annular lower fence extending axially from a center of a third bottom surface thereof, the lower fence includes an aperture communicating with the positioning slot, and including outer threads screwing with the inner threads of the valve cylinder so that the third bottom surface of the radial wall of the seat engages with the top end of the cylindrical wall; wherein

the hole is used to fit the film to the cylindrical wall of the valve cylinder, and the first bottom surface of the sealing portion is abutted against the bottom end of the annular wall, a top end of the sealing portion is limited by the third bottom surface of the radial wall of the seat; during assembling the valve cylinder, the flowing loop and the seat together, the top end of the flowing loop is spaced a height distance apart from the third bottom surface of the radial wall, and the sealing portion of the film includes a thickness distance less than the height distance so that the sealing portion includes a predetermined gap formed within the height distance to rotate the film easily.

### BRIEF DESCRIPTION OF THE DRAWINGS

FIG. 1 is a top plan view showing the assembly of a film for a flush valve according to a preferred embodiment of the present invention;

FIG. 2 is a cross sectional view showing the assembly of the film for the flush valve according to the preferred embodiment of the present invention;

FIG. 3 is a cross sectional view showing a part of the assembly of the film for the flush valve according to the preferred embodiment of the present invention;

FIG. 4 is a cross sectional view showing the assembly of a positioning set adapted for the film for the flush valve according to the preferred embodiment of the present invention;

FIG. 5 is a cross sectional view showing a part of the assembly of the film and the positioning set according to the preferred embodiment of the present invention;

FIG. 6 is a perspective view showing the assembly of a flowing loop according to the preferred embodiment of the present invention;

FIG. 7 is another perspective view showing the assembly of the flowing loop according to the preferred embodiment of the present invention;

FIG. 8 is a cross sectional view showing the assembly of the flush valve according to the preferred embodiment of the present invention;

FIG. 9 is a perspective view showing the cross sectional of the assembly of the flush valve according to the preferred embodiment of the present invention;

FIG. 10 is a perspective view showing the assembly of the film, the positioning set, and a release valve according to the preferred embodiment of the present invention;

FIG. 11 is a cross sectional view showing a part of the assembly of the flush valve according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

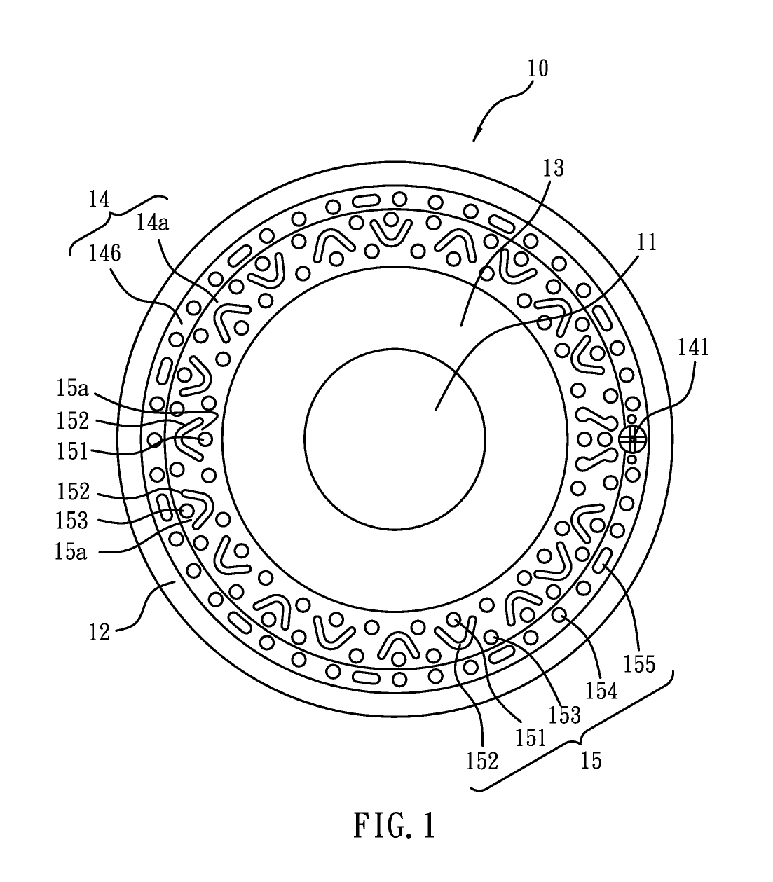

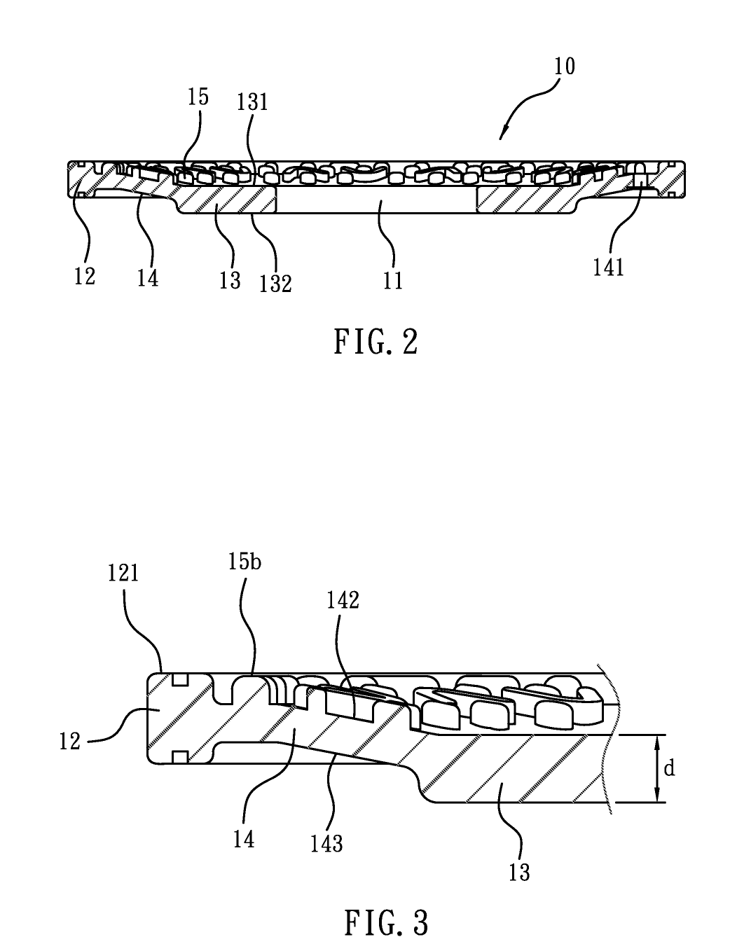

With reference to FIGS. 1-3, a film for a flush valve according to a preferred embodiment of the present invention is integrally made of ethylene propylene diene monomer (EPDM), and a hardness of the film is between shore A 70±5 degrees; the film 10 includes a circular hole 11 disposed at a central portion thereof, an annular engaging portion 12 mounted around an outer periphery thereof, a circular sealing portion 13 fixed around an outer periphery of the hole 11, and the sealing portion 13 includes a first top surface 131 and a first bottom surface 132 formed in a circular plane shape and parallel to each other, the film 10 also includes an annular pressed portion 14 located between the sealing portion 13 and the engaging portion 12 and having a bore 141 to flow water which extends upward obliquely so that the engaging portion 12 is higher than the sealing portion 13, and a thickness of the pressed portion 14 is less than those of the sealing portion 13 and the engaging portion 12, a second top surface 142 and a second bottom surface 143 of the pressed portion 14 are pressed by a water pressure to deform the pressed portion 14 flexibly, wherein the second top surface 142 of the pressed portion 14 includes a plurality of projected members 15 arranged evenly thereon, a sum of areas of the projected members 15 is between 12%-33% of an area of the second top surface 142 of the pressed portion 14.

A second top edge 151 of the projected member 15 is not higher than a first top edge 121 of the engaging portion 12, and heights of the projected members 15 are equal.

The pressed portion 14 includes an annular inner zone 14a and an annular outer zone 14b, and the annular inner zone 14a connects with the sealing portion 13 and includes a larger radial width to extend outward and upward obliquely, the annular outer zone 14b couples with the engaging portion 12 to extend horizontally and radially.

The projected member 15 includes a number of first tabs 151, second tabs 152, and third tabs 153 arranged from inside to outside of the annular inner zone 14a evenly, the first tab 151 is formed in a circle shape, the second tab 152 is formed in a V shape with an opening 15a, and the third tab 153 is formed in a circle shape as well. The openings 15a of the second tabs 152 are arranged to face inward and outerward crossly, and each inward facing opening 15a includes the first tab 151 disposed therein, each outward facing opening 15a includes the third tab 153 mounted therein.

Between two adjacent second tabs 152 are defined the first tab 151 and the third tab 153.

The projected member 15 includes a plurality of fourth tabs 154 and fifth tabs 155 arranged around the annular outer zone 14b evenly, and the fourth tab 154 is formed in a circle shape, the fifth tab 155 is formed in an elongated oval shape, between two adjacent fifth tabs 155 are defined three fourth tabs 154.

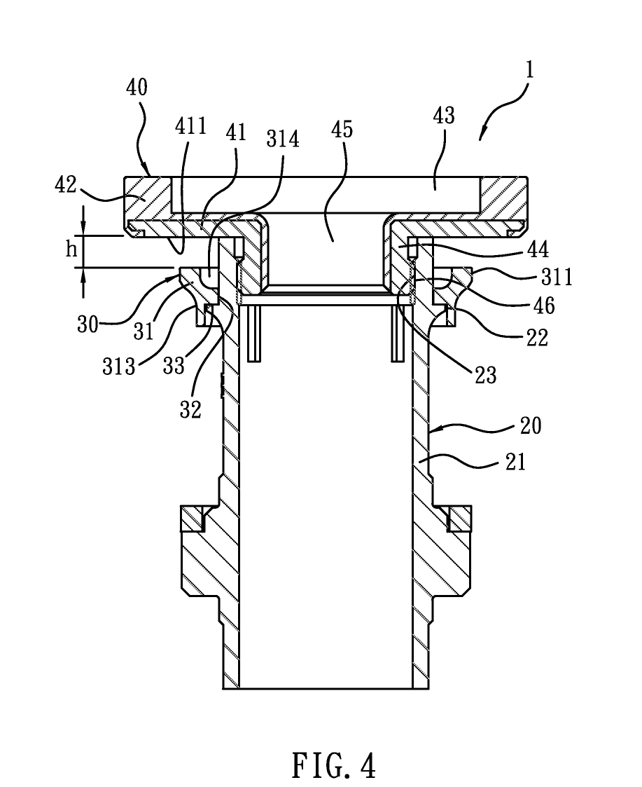

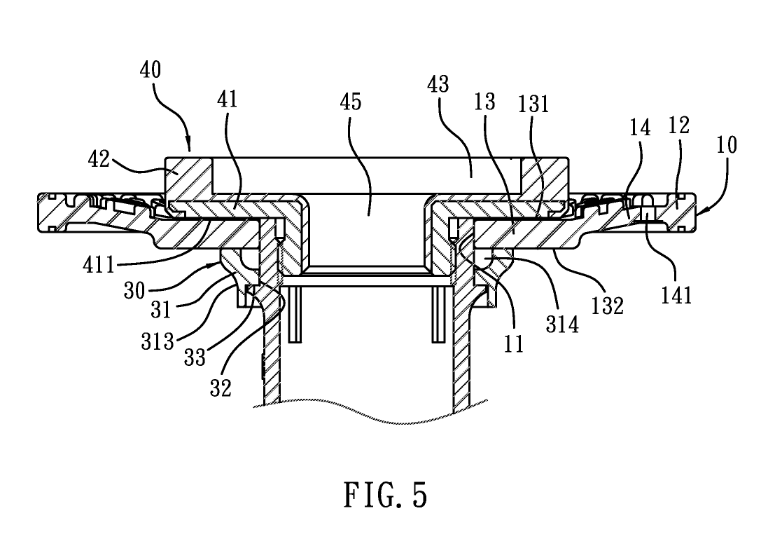

With reference to FIGS. 4-6, a positioning set 1 of the film 10 comprises a valve cylinder 20, a flowing loop 30, and a seat 40, wherein

the valve cylinder 20 includes a cylindrical wall 21, the cylindrical wall 21 includes a first fixing border 22 extending from a top end thereof and inner threads 23 disposed on an inner side thereof.

The flowing loop 30 includes an annular wall 31 in which an orifice 32 is fixed so that the lowing loop 30 is fitted to the top end of the cylinder wall 21 of the valve cylinder 20, and the flowing loop 30 includes a second fixing border 33 below the orifice 32 to engage with the first fixing border 22 of the valve cylinder 20, wherein the annular wall 31 includes an annular limiting portion 311 mounted on a top end thereof and includes a number of ribs 312 extending axially around a bottom end thereof and spaced apart from each other, and a top end of the rib 312 connects with a bottom end of the limiting portion 311, and a bottom end of the rib 312 extends toward the bottom end of the annular wall 31.

The annular wall 31 of the flowing loop 30 includes a circular groove 313 to flow water defined between the limiting portion 311 and two abutting ribs 312, and the groove 313 includes an arcuate trench extending downward increasedly.

The annular wall 31 of the flowing loop 30 includes a circular recess 314 formed on an upper side of the second fixing border 33.

The seat 40 includes a radial wall 41, an annular upper fence 42 extending axially from a top end thereof, and a positioning slot 43 defined between the radial wall 41 and the upper fence 42. The radial wall 41 includes an annular lower fence 44 extending axially from a center of a third bottom surface 411 thereof, the lower fence 44 includes an aperture 45 communicating with the positioning slot 43, and includes outer threads 46 screwing with the inner threads 23 of the valve cylinder 20 so that the third bottom surface 411 of the radial wall 41 of the seat 40 engages with the top end of the cylindrical wall 21.

The hole 11 is used to fit the film 10 to the cylindrical wall 21 of the valve cylinder 20, and the first bottom surface 132 of the sealing portion 13 is abutted against the bottom end of the annular wall 31, a top end of the sealing portion 13 is limited by the third bottom surface 411 of the radial wall 41 of the seat 40. During assembling the valve cylinder 20, the flowing loop 30, and the seat 40 together, the top end of the flowing loop 30 is spaced a height distance h apart from the third bottom surface 411 of the radial wall 41, and the sealing portion 13 of the film 10 includes a thickness distance d less than the height distance h so that the sealing portion 13 includes a predetermined gap formed within the height distance h to rotate the film 10 easily.

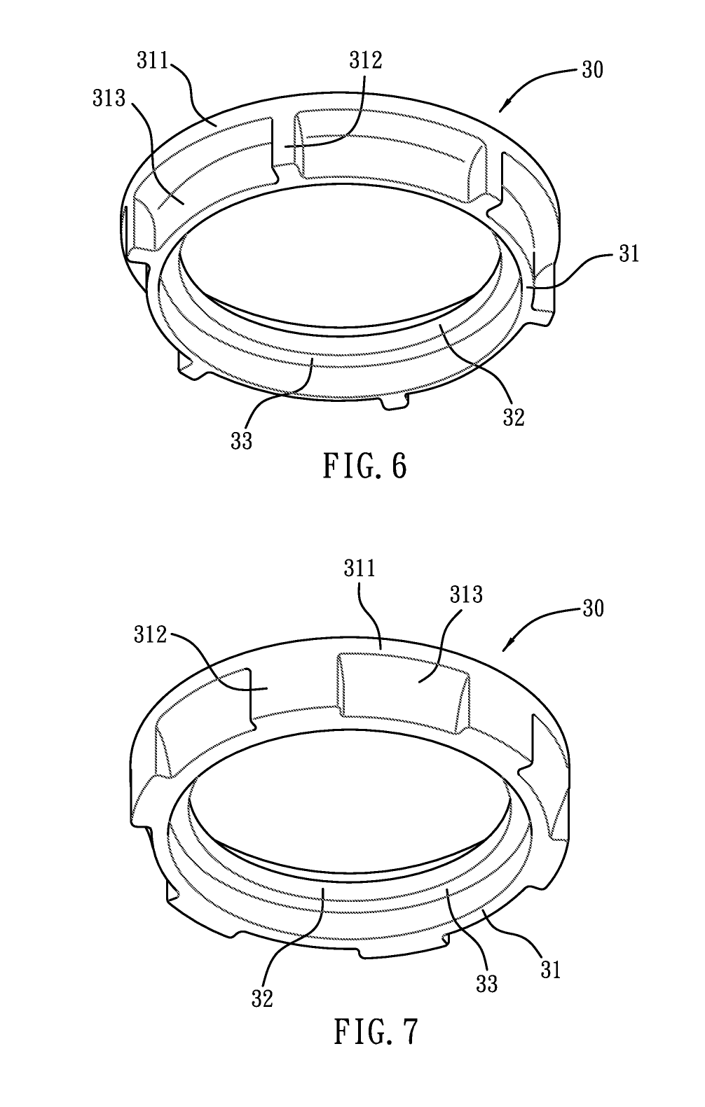

As shown in FIG. 6, because widths of the ribs 312 are smaller, the groove 313 of the flowing loop 30 is provided with a larger width to obtain a larger cross sectional area to flush water at a larger amount after draining feces by using the flush valve 2. When desiring to flush water by using the flush valve 2 after urine, another flowing loop 30 is selected as shown in FIG. 7, wherein a difference of the another flowing loop 30 from the flowing loop 30 illustrated in FIGS. 4-6 includes a width of the rib 312 is larger and a width of the groove 313 is smaller to obtain a smaller cross sectional area to flush water at a smaller amount.

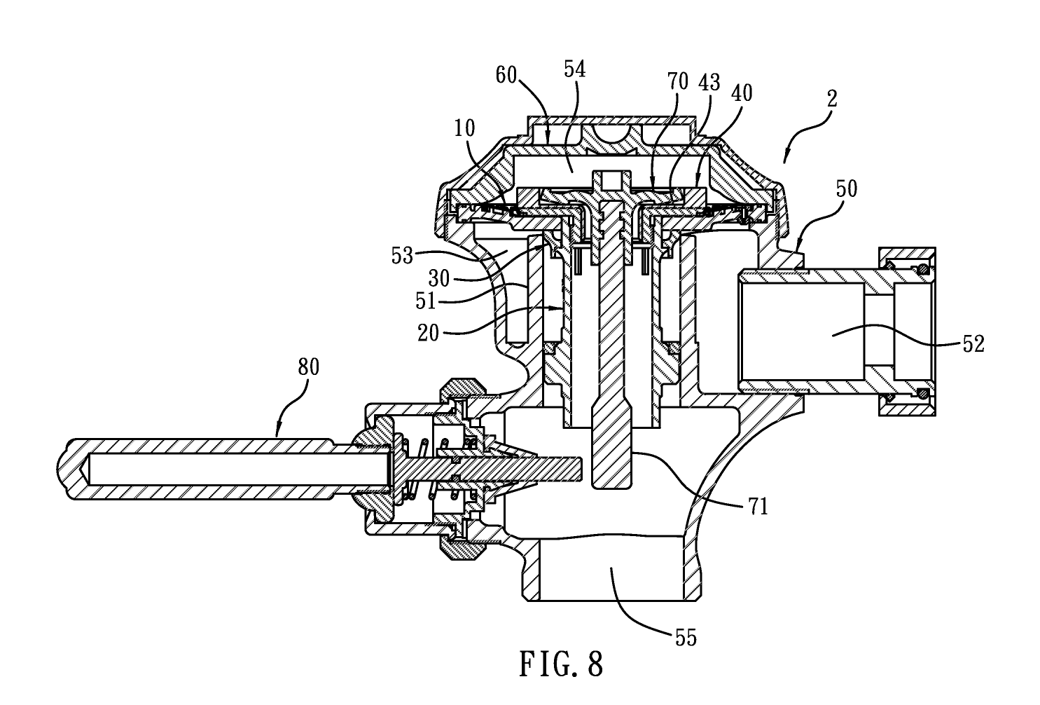

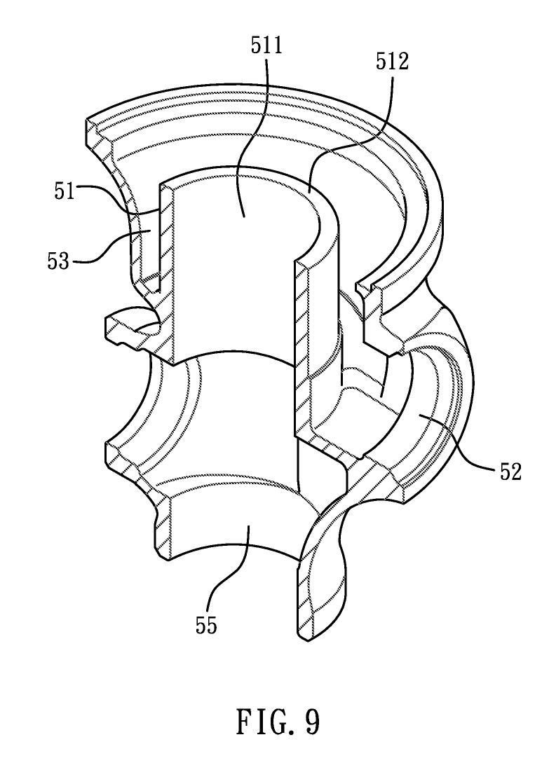

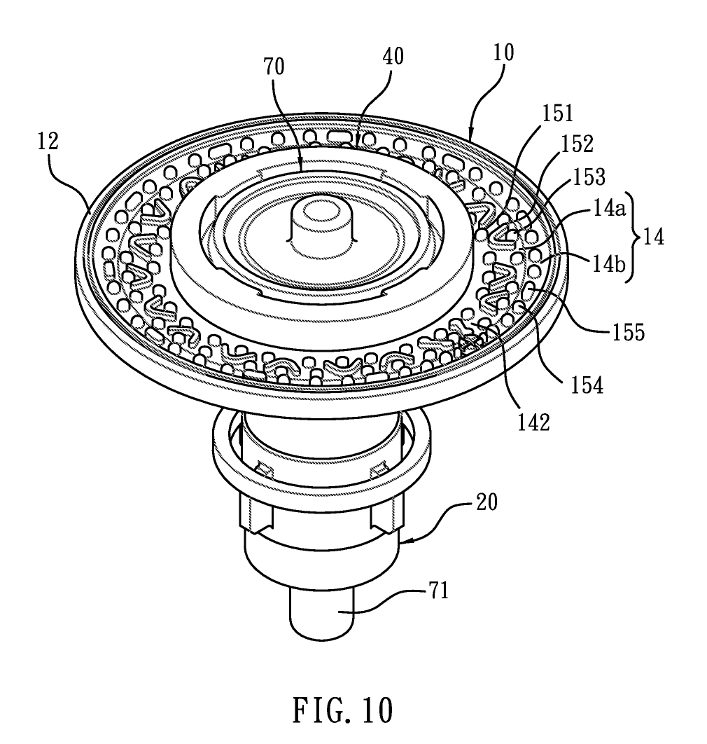

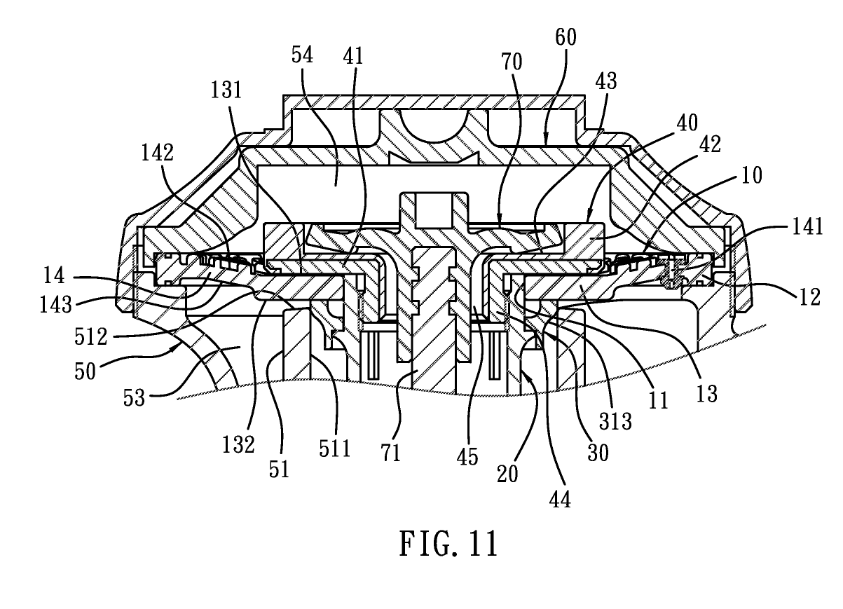

Referring to FIGS. 8-11, the assembled film 10 and positioning set 1 are installed in the flush valve 2 in a conventional installing manner as well, wherein the engaging portion 12 of the film 10 is retained between a top end of a body 50 and a cover 60 so that the ribs 312 and the limiting portion 311 of the flowing loop 30 are limited on an inner peripheral wall 511 of a top end of a tube segment 51, and the positioning slot 43 of the seat 40 includes a release valve 70 having a lever 71 extending from a bottom end of the release valve 70 so that the lever 71 is pushed to swing by a handle 80 which is fixed beside the body 50, and the release valve 70 is actuated to move obliquely, such that between the release valve 70 and the positioning slot 43 generates a water flow, hence water from an inlet 52 of the body 50 flows into a pressure room 54 above the film 10 through an inlet chamber 53 of the tube segment 51 and the bore 141 of the film 10, and then the water flows out of an outlet 55 on a bottom end of the body 50 along the aperture 45 of the seat 40 to release water pressure so that a pressure difference between the inlet chamber 53 and the pressure room 54 is generated, and then a bottom end of the pressed portion 4 of the film 10 is pressed to deform flexibly, the positioning set 1 is actuated to move upward so that the limiting portion 311 of the flowing loop 30 disengages from the inner peripheral wall 511 of the tube segment 51, hence water stored in the inlet chamber 53 flows through a slit between the grooves 313 of the flowing loop 30 and the inner peripheral wall 511 of the tube segment 51 and further flows out of the outlet 55 of the tube segment 51. During water flushing process, water in the inlet chamber 53 flows into the pressure room 54 via the bore 141 of the film 10 to supply waters so that water pressure in the pressure room 54 increases with water supplement, and when the pressure is stored toward a certain pressure, the sealing portion 13 of the film 10 is pushed downward until the first bottom surface 132 engages with the third top edge 512 of the tube segment 51 tightly to stop water supply, finish the water flushing process.

The second top surface 142 of the pressed portion 14 of the film 10 is not deformed easily by using the projection member 15, and the V-shaped second tabs 152 of the projected members 15 can reinforce the film 10 so that flexible recovering force and the flexible deformation of the pressed portion 14 are balanced.

The film 10 is deformed by the water pressure to expand and retract suitably so as to achieve stable water flush and water stop.

The flowing loop 30 and the recess 314 serve to decrease a friction area as the film 10 retracts to stabilize the retracted film 10.

The film 10 can deform, expand, and retract stably under any water pressures by ways of a structure between the flowing loop 30 and the seat 40 so as to stop water well.

The groove 313 of the flowing loop 30 is formed in a circle shape to flow water smoothly, therefore under a lower water pressure within the same flushing time, the present invention can generate stronger water flush.

While we have shown and described various embodiments in accordance with the present invention, it is clear to those skilled in the art that further embodiments may be made without departing from the scope of the present invention.

What is claimed is:

1. A film for a flush valve being integrally made of ethylene propylene diene monomer (EPDM), and a hardness of the film being between shore A 70±5 degrees; the film comprising
a circular hole disposed at a central portion thereof, an annular engaging portion mounted around an outer periphery thereof, a circular sealing portion fixed around an outer periphery of the hole, and the sealing portion including a first top surface and a first bottom surface formed in a circular plane shape and parallel to each other, the film also comprising an annular pressed portion located between the sealing portion and the engaging portion and having a bore to flow water which extends upward obliquely so that the engaging portion is higher than the sealing portion, and a thickness of the pressed portion is less than those of the sealing portion and the engaging portion, a second top surface and a second bottom surface of the pressed portion are pressed by a water pressure to deform the pressed portion flexibly;
wherein the second top surface of the pressed portion includes a plurality of projected members arranged evenly thereon, a sum of areas of the projected members is between 12%-33% of an area of the second top surface of the pressed portion.

2. The film for the flush valve as claimed in claim 1, wherein a second top edge of the projected member is not higher than a first top edge of the engaging portion.

3. The film for the flush valve as claimed in claim 1, wherein heights of the projected members are equal

4. The film for the flush valve as claimed in claim 1, wherein the pressed portion includes an annular inner zone and an annular outer zone, and the annular inner zone connects with the sealing portion and includes a larger radial width to extend outward and upward obliquely, the annular outer zone couples with the engaging portion to extend horizontally and radially.

5. The film for the flush valve as claimed in claim 4, wherein the projected member includes a number of first tabs, second tabs, and third tabs arranged from an inside to an outside of the annular inner zone evenly, the first tab is formed in a circle shape, the second tab is formed in a V shape with an opening, and the third tab is formed in a circle shape; the openings of the second tabs are arranged to face inward and outerward crossly, and each inward facing opening includes the first tab disposed therein, each outward facing opening includes the third tab mounted therein.

6. The film for the flush valve as claimed in claim 5, wherein between two adjacent second tabs are defined the first tab and the third tab.

7. The film for the flush valve as claimed in claim 4, wherein the projected member includes a plurality of fourth tabs and fifth tabs arranged around the annular outer zone evenly, and the fourth tab is formed in a circle shape, the fifth tab is formed in an elongated oval shape, between two adjacent fifth tabs are defined three fourth tabs.

8. A positioning set adapted for the film for flush valve as claimed in claim 1 comprising
a valve cylinder including a cylindrical wall, the cylindrical wall including a first fixing border extending from a top end thereof and inner threads disposed on an inner side thereof;
a flowing loop including an annular wall in which an orifice is fixed so that the lowing loop is fitted to the top end of the cylinder wall of the valve cylinder, and the flowing loop including a second fixing border below the orifice to engage with the first fixing border of the valve cylinder, wherein the annular wall includes an annular limiting portion mounted on a top end thereof and includes a number of ribs extending axially around a bottom end thereof and spaced apart from each other, and a top end of the rib connects with a bottom end of the limiting portion, a bottom end of the rib extends toward the bottom end of the annular wall;
a seat including a radial wall, an annular upper fence extending axially from a top end thereof, and a positioning slot defined between the radial wall and the upper fence; the radial wall including an annular lower fence extending axially from a center of a third bottom surface thereof, the lower fence includes an aperture communicating with the positioning slot, and including outer threads screwing with the inner threads of the valve cylinder so that the third bottom surface of the radial wall of the seat engages with the top end of the cylindrical wall; wherein
the hole is used to fit the film to the cylindrical wall of the valve cylinder, and the first bottom surface of the sealing portion is abutted against the bottom end of the annular wall, a top end of the sealing portion is limited by the third bottom surface of the radial wall of the seat; during assembling the valve cylinder, the flowing loop and the seat together, the top end of the flowing loop is spaced a height distance apart from the third bottom surface of the radial wall, and the sealing portion of the film includes a thickness distance less than the height distance so that the sealing portion includes a predetermined gap formed within the height distance to rotate the film easily.

9. The positioning set as claimed in claim 8, wherein the annular wall of the flowing loop includes a circular groove to flow water defined between the limiting portion and two abutting ribs, and the groove includes an arcuate trench extending downward increasedly.

10. The positioning set as claimed in claim 8, wherein the annular wall of the flowing loop includes a circular recess formed on an upper side of the second fixing border.
